(19) United States
(12) Patent Application Publication
(10) Pub. No.: US 2009/0255254 A1
(43) Pub. Date: Oct. 15, 2009

(54) Method and device for increasing the energy efficiency of a power plant

(75) Inventors: Vladimir Danov, Erlangen (DE); Bernd Gromoll, Baiersdorf (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Seimens Aktiengesellschaft

(21) Appl. No.: 12/384,322

(22) Filed: Apr. 2, 2009

(30) Foreign Application Priority Data
Apr. 9, 2008 (DE) 10 2008 017 998.1

(51) Int. Cl. F01K 13/00; F02G 3/00; F25B 9/14

(52) U.S. Cl. 60/645; 60/39.5; 62/6

(57) ABSTRACT

The invention relates to improving the efficiency or the energy balance of a power plant. Here, the heat content waste heat from the power plant is employed in such a way that the waste heat is fed into a first and/or a second thermoacoustic machine. In the first thermoacoustic machine a work output is generated with the aid of the waste heat and as a result of the thermoacoustic effect, which is employed elsewhere in the power plant, for example to operate a compressor. The second thermoacoustic machine is likewise used for cooling a working fluid by utilizing the waste heat and the thermoacoustic effect.

### CROSS REFERENCE TO RELATED APPLICATIONS

This application claims priority of German application No. 10 2008 017 998.1 filed Apr. 9, 2008, which is incorporated by reference herein in its entirety.

### FIELD OF THE INVENTION

The invention relates to a method and a device for increasing the energy efficiency of a power plant.

### BACKGROUND OF THE INVENTION

The waste heat produced in power plants, which arises after combustion of the fuel and behind the turbine, contains large reserves of energy, in particular in the form of (residual) heat. The reserves of energy can be used to supply various processes in the power plant with energy. It is for example not unusual to preheat combustion air with the aid of the waste heat from the power plant, in order to achieve more effective combustion. Other applications are also possible, such as for example the generation of electricity for equipment of the power plant or for feeding into the electricity network.

### SUMMARY OF THE INVENTION

Customary methods for using the waste heat are costly and low in efficiency. It is thus the object of the invention to specify a method, with which waste heat usage in a power plants is possible with a higher degree of efficiency.

This object is achieved by means of the inventions specified in the independent claims. Advantageous embodiments emerge from the dependent claims.

In the inventive method, the so-called thermoacoustic effect is exploited in such a way that the waste heat from a power plant is used, for example for the generation of work output P for a compressor and/or for the generation of cold. In the case of the thermoacoustic effect sound waves are initially generated in a heat transmission medium by means of a acoustic source, for example by means of a loudspeaker, as described, for example, in DE 43 03 052 A1. The heat transmission medium is located in a resonance tube, in the longitudinal direction of which the sound waves are radiated. The thermoacoustic effect consists essentially in the fact that a temperature gradient arises between certain positions in the longitudinal direction of the tube. Via suitable heat exchangers, which are arranged precisely at these positions, heat can be given off into the environment or heat can be absorbed from the environment.

The thermoacoustic effect can be reversed, for example in such a way that via appropriate heat exchangers, a temperature gradient is generated, which results in pressure fluctuations being triggered in the medium.

The present invention makes use of this reversed thermoacoustic effect in an exemplary embodiment in such a way that in a first thermoacoustic machine pressure fluctuations are generated in a heat transmission medium via a first heat exchanger, which is flowed through by a medium with a higher temperature, and a second heat exchanger, which is flowed through by a cooler medium. The particular advantage of the invention lies in the fact that the waste heat from the power plant is removed from the hot medium flowing through the first heat exchanger. What are in particular involved here are hot flue gases and/or the steam from the power plant. The medium flowing through the second heat exchanger can be realized by a customary coolant, that is cooling water or cooling air.

The pressure fluctuations in the heat transmission medium have an effect on a device for power generation, which contains components which are set in motion by the pressure fluctuations. In the simplest case this can be a piston, which performs a linear movement in a cylinder according to the pressure fluctuations, which is converted into a rotational motion, for example via a crankshaft.

The work output thus generated can be passed on in the form of mechanical or electrical power. In the exemplary embodiment, the work output is transmitted to a compressor, which compresses the air to be broken down as part of an air-separation unit. Optimally, the work output which can be generated with the first thermoacoustic machine is sufficient on its own to drive the compressor. It is otherwise conceivable to connect up a further energy source to supply the compressor.

FIG. 1 shows in diagrammatic form two possibilities for using the thermoacoustic effect. In FIG. 1a a work output P is thereby generated in a device for power generation 130, as already briefly described above, such that a first heat exchanger 110 and a second heat exchanger 120 of a first thermoacoustic machine 100 are flowed through by media having different temperatures. In FIG. 1b, on the other hand, a second thermoacoustic machine 200 functions in a known manner as a refrigeration machine in such a way that a third heat exchanger 210 is flowed through by a medium with a high temperature, while a device for the supply of power 230 generates pressure fluctuations in the heat transmission medium of the second thermoacoustic machine. This has the effect that because of the thermoacoustic effect, a medium flowing through a fourth heat exchanger 220 is cooled. In principle, the device for the supply of power 230 can here constructed like the device for power generation, with the difference that in the case of the device for the supply of power, the piston or the crankshaft are driven from outside.

Alternatively or in addition to the use of the first thermoacoustic machine, the present invention employs the thermoacoustic effect as described in connection with FIG. 1b in a refrigeration plant: Here, the hot medium flowing through the third heat exchanger 210 comprises—as in the case of the first heat exchanger 110—the hot flue gases and/or the steam from the waste heat from the power plant. The medium flowing through the fourth heat exchanger is the air already compressed in the compressor, which is cooled in the fourth heat exchanger.

As an alternative to concrete use for an air-separation unit, the first thermoacoustic machine can, for example, also be used to drive a generator for the generation of electricity, while the second thermoacoustic machine is generally usable to cool any medium desired.

Accordingly, the invention offers the particular advantage that the energy demands or energy balance of a complete plant comprising power plant and for example the air-separation unit, is improved, as the energy required for compression and/or cooling of the air is derived from the otherwise unused waste heat from the power plant.

### BRIEF DESCRIPTION OF THE DRAWINGS

Further advantages, features and details of the invention emerge from the exemplary embodiment described in the following, and the drawings. Where:

FIG. 1a shows a first possibility for making use of the thermoacoustic effect,

FIG. 1b shows a second possibility for making use of the thermoacoustic effect,

FIG. 2 shows a diagrammatic view of an oxyfuel power plant and

FIG. 3 shows an inventive air-separation unit.

### DETAILED DESCRIPTION OF THE INVENTION

Various methods are known for the reduction of CO2 emissions from power plants, in which CO2 is separated from the combustion or flue gases from the power plant, so that it can subsequently be separately accumulated or stored. The separation is necessary, as only a small proportion of the waste gas from the power plants consists of CO2: The majority is nitrogen, which is contained, along with oxygen in the ambient air. As it makes no sense to store the harmless nitrogen by geological means, the CO2 must first be separated from the nitrogen and where applicable other substances contained in the waste gas.

In oxyfuel power plants operating according to the oxyfuel method, the fuel is not burned with air but with pure oxygen. This has the advantage of a very high concentration of CO2 in the resultant flue gas, which significantly simplifies the subsequent separation of CO2 from the flue gas. An air-separation unit 1 is inserted upstream of the oxyfuel power plant 2, symbolically represented in FIG. 2 by a burner 3 and a turbine 4, in which the oxygen required for combustion is produced. Here, the air-separation unit 1 is fed with air via a line 40. The oxygen separated out of the air is directed via a line 331 to the burner 3, where finally the fuel B can be burned with pure oxygen. The turbine 4 is finally coupled with a generator 5. The waste heat from the power plant, in particular hot flue gases and steam, are carried away via a waste heat line 6.

Methods for the breaking-down of air are known. Usually, the air to be broken down is first compressed, then cooled down and finally separated into its components. Depending on the manufacturer, various compressors, refrigeration plants and distillation columns are used in the air-separation unit. However the common factor shared by known methods is comparatively high energy requirements, resulting in poor power plant efficiency.

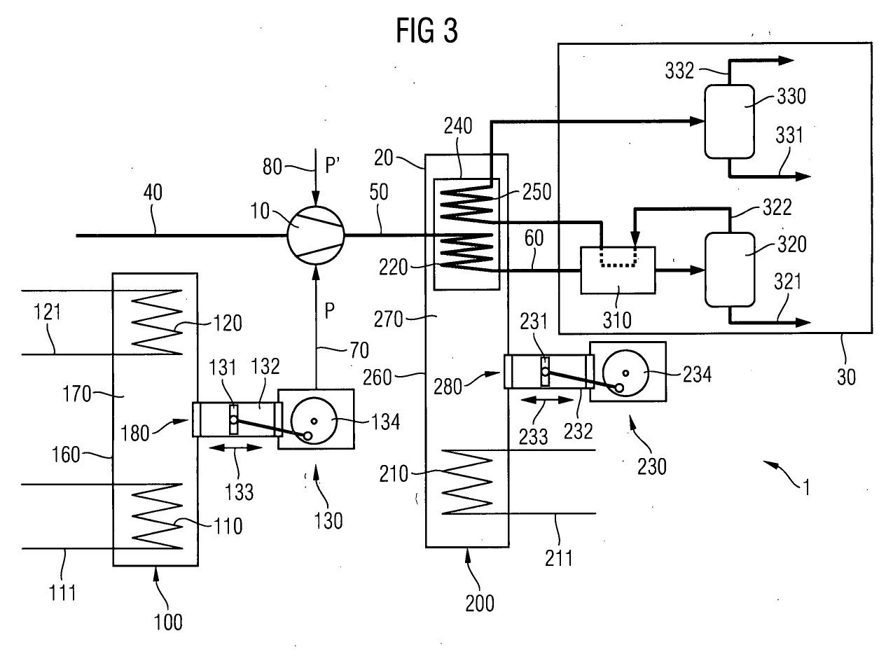

FIG. 3 shows a diagrammatic view of an air-separation unit 1. This comprises a compressor 10 for compressing the air to be broken down, a refrigeration plant 20 for cooling the air compressed by the compressor 10 and a separation device 30. The air to be broken down is conveyed to the compressor 10 via a line 40, and compressed there. The compressed air is passed on to the refrigeration plant 20 via a further line 50, where it is cooled down in a cooling facility 240 of the refrigeration plant 20. The cooling facility 240 comprises at least one, in the present embodiment two heat exchangers 220, 250, which are further described below. Cooling of the compressed air takes place in the heat exchanger 220, designated hereinafter as the fourth heat exchanger 220. The heat exchanger 250 is designated as the fifth heat exchanger 250.

From the outlet of the cooling facility 240, the now compressed and cooled down air passes via a line 60 into the separation device 30, where, if applicable, it is further cooled down in a further cooling facility 310. In the separation device 30, the compressed and cooled air is broken down into its components (nitrogen, oxygen, inert gases) in a multistep process, where each process step separates out one of the components and the remainder is passed on for the next process step. To this end, a first and a second distillation column 320, 330 are provided.

In the first distillation column 320, nitrogen is separated out in a known manner, and carried off via a line 321. The remaining nitrogen-poor air is fed to the second distillation column 330 via a line 322. In the present exemplary embodiment, the nitrogen-poor air is subjected to intermediate cooling, before reaching the second distillation column 330. To this end it is passed through the further cooling facility 310 and/or through the fifth heat exchanger 250 provided in the cooling facility 240 of the refrigeration plant 20.

In the second distillation column 330, the oxygen contained in the nitrogen-poor air is separated out in a known manner, and carried away via a line 331. The residue from this process consists solely of inert gases, which are carried away via the line 332.

As already indicated in FIG. 2, the oxygen carried away via the line 331 is used in an oxyfuel power plant 2, in order to burn a fuel B in a burner 3 with pure oxygen, and thus to achieve the desired high concentration of CO2 in the flue gases.

According to the invention, a first 100 and/or a second thermoacoustic machine 200 are employed in the air-separation unit 1, which are operated by the waste heat from the power plant 2.

The first thermoacoustic machine 100 generates at least a part of the work output P required by the compressor 10 for compressing the air to be broken down. To this end, the first thermoacoustic machine 100 has a first container 160, which can, for example, be embodied as a resonance tube, and which comprises a first heat exchanger 110, a second heat exchanger 120 and a first heat transmission medium 170, for example air. The first 110 and the second heat exchanger 120 are in thermal contact via the first heat transmission medium 170.

The first heat exchanger 110 is now flowed through by a first medium and the second heat exchanger 120 by a second medium, where the temperature of the first medium is higher than the temperature of the second medium. According to the invention, the first heat exchanger 110 is in particular fed via a supply line 111 with the waste heat from the oxyfuel power plant, in particular with hot flue gas and/or steam. To this end, the supply line 111 is connected with the waste heat line 6 from the power plant 2. The second heat exchanger 120 is supplied with the coolant, in particular with cooling air or cooling water via a supply line 121. As indicated in FIG. 2, the waste heat can, for example, be removed behind the burner 3 and/or behind the turbine 4.

Because of the thermoacoustic effect, the temperature gradient between the first 110 and the second heat exchanger 120 results in pressure fluctuations being generated in the resonance tube 160 in the first heat transmission medium 170. A device for power generation 130 is coupled with the first thermoacoustic machine 100 in such away that these pressure fluctuations can have an effect on the device for power generation 130.

The device for power generation 130 can, for example, comprise a piston 131, a cylinder 132 and a crankshaft 134, where the cylinder 132 is arranged on an aperture 180 in the resonance tube 160, so that forces are generated on the piston 131 as a result of the pressure fluctuations. The piston 131 moves thereby in the direction of the arrow 133, actuates the crankshaft 134 and thus generates a work output P, which is finally transmitted to the compressor 10 via a line 70. It is conceivable here to operate a generator (not shown) for the generation of electricity by means of the crankshaft 134, and to supply the compressor 10 with the generated electricity. In this case, the line 70 is a conductive connection. Alternatively, the crankshaft 134 can be mechanically connected with a shaft of the compressor 10, so that the compressor is driven directly. In this case, the line 70 represents a mechanical connection between the device for power generation 130 and the compressor 10. In general terms it can be stated that the device for power generation 130 is in a position to absorb the pressure fluctuations in the resonance tube 160 and convert them into a work output P. Devices of this kind for power generation are known to a person skilled in the art. For example a linear compressor can be used, which combines the device for power generation 130 and the compressor 10 within itself.

An additional work output P′ can be fed to the compressor 10 if necessary via an optional supply line 80, if the work output P generate by the first thermoacoustic machine 100 is not enough to compress the air to be broken down sufficiently.

Alternatively or in addition to use of the first thermoacoustic machine 100 a second thermoacoustic machine 200 can be employed as a refrigeration machine in the refrigeration plant 20. The second thermoacoustic machine 200 is used to cool the air compressed in the compressor 10. To this end the second thermoacoustic machine 200 has a second container or a second resonance tube 260, which contains a third heat exchanger 210, the cooling facility 240 already introduced, with the fourth 220 and fifth heat exchanger 250 and a second heat transmission medium 270, for example air. The third heat exchanger 210 is in thermal contact with the cooling facility 240 or with the fourth 220 and the fifth heat exchanger 250 via the second heat transmission medium 270.

A device for the supply of power 230 is coupled with the second thermoacoustic machine 200 or with its resonance tube 260 for example via an aperture 280 in such a way that pressure fluctuations generated in the second heat transmission medium 270 or pressure fluctuations already present can be strengthened. The device for the supply of power 230 can, for example, comprise a piston 231 and a cylinder 232, where the cylinder 232 is arranged on the aperture 280 in the resonance tube 260. The piston 231 is, for example, moved in the direction of the arrow 233 via a crankshaft 234 for the generation of the pressure fluctuations. Alternatively, the device for the supply of power 230 can also be embodied as an acoustic source, for example as a loudspeaker or the like. The only important factor is that pressure fluctuations can be generated in the second heat transmission medium 270.

The third heat exchanger 210 is now flowed through by a third medium at a high temperature. In particular, according to the invention, the third heat exchanger 210 is fed, like the first heat exchanger 110, with the waste heat from the oxyfuel power plant 2 via a supply line 211, in particular with hot flue gas and/or steam. To this end, the supply line 211 is connected with the waste heat line 6 from the power plant 2. As indicated in FIG. 2, the waste heat can, for example, be removed behind the burner 3 and/or behind the turbine 4.

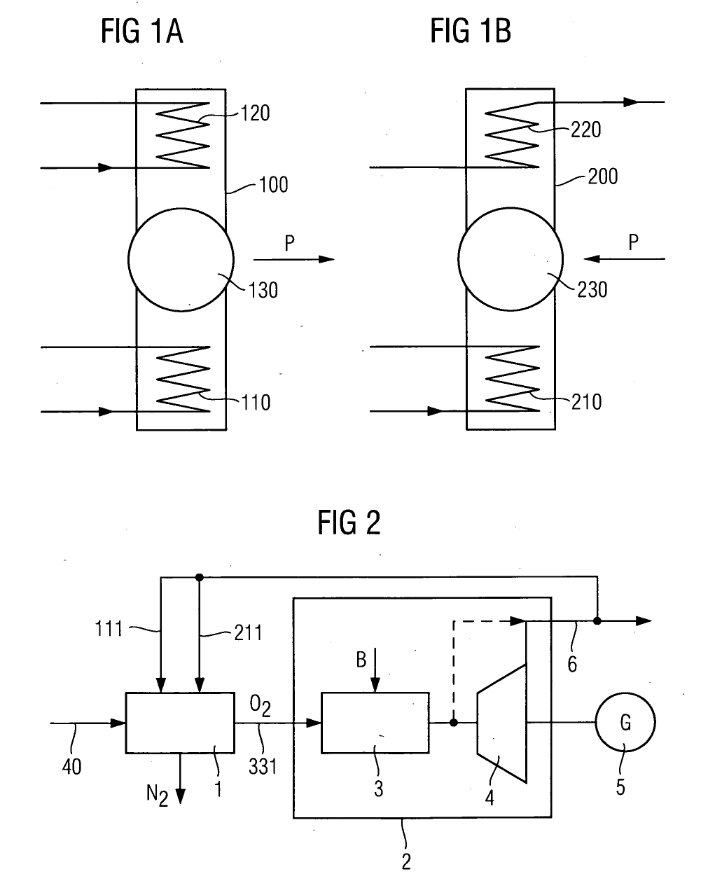

The fourth heat exchanger 220 is flowed through by the air compressed in the compressor 10. By means of the thermoacoustic effect described in connection with FIG. 1b, the air in the fourth heat exchanger 220 can be caused to be cooled. In addition, the nitrogen-poor air emanating from the first distillation column 320 is subject to intermediate cooling in the fifth heat exchanger 250.

As already described, the air cooled in the first heat exchanger 220 then passes via the line 60 into the separation device 30, where the oxygen for the combustion is ultimately separated out.

The above embodiments relate to the compression and cooling of air. It is, however, clear that the inventive device and the method are not just applicable to the processing of air, but are generally suitable for the compression and cooling in particular of a gaseous working fluid.

Furthermore, the first thermoacoustic machine 100 is generally suitable for converting the energy contained in the waste heat from the power plant 2 into a mechanical or electrical work output P, which can be utilized by one or more consumers, for example pumps, wherever desired. The example of the air-separation unit cited is only one concrete application.

The method and device can particularly advantageously be used for breaking down air for an oxyfuel power plant, as its waste heat is used to obtain one of the necessary raw materials.

1-20. (canceled)

21. A method for using waste heat from a power plant, comprising:
feeding the waste heat to a first thermoacoustic machine or a second thermoacoustic machine.

22. The method as claimed in claim 21, wherein the first thermoacoustic machine generates a mechanical or electrical work output and the second thermoacoustic machine generates a cold.

23. The method as claimed in claim 22, wherein the work output is fed to a compressor for compressing a working fluid and the cold is used to cool the working fluid.

24. The method as claimed in claim 23,
wherein the first thermoacoustic machine comprises a first heat exchanger and a second heat exchanger,
wherein the first heat exchanger is thermally contacted with the second heat exchanger via a first heat transmission medium, and
wherein the work output is converted by a pressure fluctuation that is generated in the first heat transmission medium by a thermoacoustic effect.

25. The method as claimed in claim 24, wherein the waste heat is fed to the first heat exchanger and a coolant is fed to the second heat exchanger.

26. The method as claimed in claim 25,
wherein the second thermoacoustic machine comprises a third heat exchanger and a cooling device comprising a fourth heat exchanger,
wherein the third heat exchanger is thermally contacted with the cooling device and the fourth heat exchanger via a second heat transmission medium, and
wherein the working fluid flows through the fourth heat exchanger and is cooled by the thermoacoustic effect.

27. The method as claimed in claim 26, wherein the waste heat is fed to the third heat exchanger and a power supply device generates a pressure fluctuation in the second heat transmission medium or strengthens an existing pressure fluctuation.

28. The method as claimed in claim 26,
wherein a separation device brakes down the compressed and cooled working fluid into components of the working fluid in a multistage process, and
wherein each process stage separates out one of the components and a residual medium is directed to a subsequent next process stage.

29. The method as claimed in claim 28, wherein the cooling device of the second thermoacoustic machine comprises a fifth heat exchanger that cools the residual medium between two process stages.

30. The method as claimed in claim 21, wherein the waste heat is removed behind a burner or behind a turbine of the power plant.

31. A power plant, comprising:
a first thermoacoustic machine;
a second thermoacoustic machine; and
a waste heat line that connects the first thermoacoustic machine or the second thermoacoustic machine to carry away a waste heat produced in the power plant.

32. The power plant as claimed in claim 31,
wherein the second thermoacoustic machine comprises a cooling device comprising a fourth heat exchanger that cools a working fluid, and
wherein the first thermoacoustic machine is connected with a compressor that compresses the working fluid.

33. The power plant as claimed in claim 32,
wherein the first thermoacoustic machine comprises a first heat exchanger and a second heat exchanger that are thermally contacted via a first heat transmission medium,
wherein the first heat exchanger is connected with the waste heat line via a first supply line, and
wherein the second heat exchanger is supplied with a coolant via a second supply line.

34. The power plant as claimed in claim 33, wherein a power generation device is coupled with the first thermoacoustic machine and converts a pressure fluctuation of the first heat transmission medium generated by a thermoacoustic effect into a work output.

35. The power plant as claimed in claim 34, wherein the power generation device is jointly connected with the compressor as a linear compressor and comprises components for generating the work output by the pressure fluctuation.

36. The power plant as claimed in claim 35, wherein the power generation device is connected with the compressor via a line for transmitting the work output to the compressor.

37. The power plant as claimed in claim 36,
wherein the second thermoacoustic machine comprises a third heat exchanger and a cooling device comprising a fourth heat exchanger,
wherein the third heat exchanger is thermally contacted with the cooling device and the fourth heat exchanger via a second heat transmission medium,
wherein the third heat exchanger is connected with the waste heat line via a third supply line, and
wherein the working fluid flows through the fourth heat exchanger.

38. The power plant as claimed in claim 37, wherein a power supply device is coupled to the second thermoacoustic machine and generates the pressure fluctuation in the second heat transmission medium or strengthens an existing pressure fluctuation.

39. The power plant as claimed in claim 38, wherein the power supply device is an acoustic source and comprises components for generating the pressure fluctuation in the second heat transmission medium.

40. The power plant as claimed in claim 39, wherein an outlet of the compressor is connected with an input of the fourth heat exchanger via a line for the working fluid.
